(19) United States
(12) Patent Application Publication
(10) Pub. No.: US 2026/0002050 A1
(43) Pub. Date: Jan. 1, 2026

(54) OPTICALLY CLEAR PRESSURE SENSITIVE ADHESIVES WITH A LOW DIELECTRIC CONSTANT

(71) Applicant: 3M INNOVATIVE PROPERTIES COMPANY, St. Paul, MN (US)

(72) Inventor: Sung-Tso Lin, Taoyuan City (TW)

(21) Appl. No.: 19/130,211

(22) PCT Filed: Nov. 15, 2023
(86) PCT No.: PCT/IB2023/061581

§ 371 Date: May 15, 2025

Related U.S. Application Data
(60) Provisional application No. 63/426,824, filed on Nov. 21, 2022.

(51) Int. Cl. C09J 7/38; C09J 133/10

(52) U.S. Cl. CPC C09J 7/385; C09J 133/10; C09J 2203/326

(57) ABSTRACT

In order to suppress deterioration of electric characteristics and to achieve superior transparency, durability and moisture resistance in an adhesive layer, this transparent conductive sheet comprises an adhesive layer which is contacts a conducting layer and which contains an acrylic copolymer which has a weight average molecular weight Mw exceeding 100,000 and less than or equal to 2,000,000 and contains, as a copolymer monomer component, hydrophobic monomers selected from alkyl methacrylates having a linear or branched alkyl group of 1-9 carbon atoms, alkyl(meth)acrylates having a cyclic alkyl group of 5-9 carbon atoms and alkyl(meth)acrylates having an alkyl group of 10-20 carbon atoms. The total blending ratio of the hydrophobic monomers in the copolymer monomer component of the acrylic copolymer is greater than or equal to 35 mass % of the total mass of the acrylic copolymer, and the haze value is less than or equal to 1.0 when the thickness of the adhesive layer is 100 μm; this touch panel module and touch panel device use said transparent conductive sheet.

### SUMMARY

Disclosed herein are optically clear pressure sensitive adhesives compositions that have a low dielectric constant. Also disclosed are adhesive articles prepared from these optically clear pressure sensitive adhesives.

In some embodiments, the adhesive composition comprises the reaction product of a mixture comprising at least one first monomer comprising a methacrylate, at least one second monomer comprising a low Tg (meth)acrylate monomer with a Tg of −15° C. or less, the (meth)acrylate having an alkyl group with 2-20 carbon atoms, at least one third monomer comprising a high Tg monomer with a Tg of 70° C. or higher, where the high Tg monomer comprises a (meth)acrylate monomer, a (meth)acrylamide monomer, or a vinyl-functional monomer and at least one initiator. The adhesive is free from acid-functional groups; is a pressure sensitive adhesive; is optically clear having a visible light transmission of 90%, a haze value of 1% or less, and a b* color value of 1 or less. The adhesive has a low dielectric constant having a dielectric constant (Dk) of 3.1 or less at 25° C. and 100 kHz.

Also disclosed are adhesive articles. In some embodiments, the adhesive article comprises a first substrate with a first major surface and a second major surface, and an adhesive layer disposed on at least a portion of the second major surface of the first substrate, the adhesive layer comprising the adhesive composition described above.

### DETAILED DESCRIPTION

A wide range of optical articles have multiple layers. The multiple layers often are adhered to each other with adhesive layers. These adhesive layers have a wide range of desired or required properties. Besides the mechanical property of adhesion, adhesives typically have other desirable properties such as optical or electric properties. Achieving a range of properties is a very complex process, because often imparting one property to the adhesive layer causes detrimental effects to other properties.

An example of new classes of adhesives that have been developed to provide desirable properties are optically clear adhesives (OCAs). A range of optically clear adhesives have been developed for use in optical articles. These adhesives have the desirable combination of adhesive properties and optical properties that enable their use in a wide range of optical articles. As the use of these adhesives has increased it has become apparent that it is desirable for these adhesives to have additional properties. However, these new properties cannot be achieved by sacrificing the adhesive or optical properties.

As optically clear adhesives have found wider use, additional requirements for these adhesives have become apparent. Among these requirements are modulus (a measure of the relative stiffness or softness), high temperature stability (not changing properties upon exposure to high temperatures), compatibility with a wide range of electronic or optical elements such as wires, since many of these electronic or optical elements are sensitive to components often used in adhesives (such as acids), and a low dielectric constant.

Modifying an OCA to provide additional desirable properties needs to be done with care, since altering one property can cause undesirable changes in other properties. For example, for many optical and electronic devices, it may be desirable to utilize adhesives with a low modulus for uses such as gap filling layers between substrates in the devices. However, low modulus adhesives have decreased cohesive strength and therefore are more susceptible to flowing or degrading at elevated temperatures. Also, long chain hydrocarbon monomers are useful in forming adhesive polymers with a low dielectric constant, but these polymers tend to be cohesively weak. To increase the cohesive strength, typically reinforcing monomers are used. Among the more common reinforcing monomers are acid-functional monomers and aromatic monomers such as styrene. However, aromatic monomers tend to raise the dielectric constant of the formed polymer, and acid-functional monomers tend to be corrosive to, for example, wires of electronic devices.

Thus, there is a need for adhesives with a variety of desirable properties. Not only do the adhesives need to have useful adhesive and optical clarity properties, but also a suitably low modulus for gap filling properties, high temperature stability, non-corrosive towards elements such as wires, and a low dielectric constant.

Disclosed herein are adhesives that have a balance of properties of desirable adhesion, optical clarity, suitable modulus, high temperature stability, non-corrosive to wires such as silver nanowires, and a low dielectric constant. Also disclosed are articles that contain these adhesives.

The term “adhesive” as used herein refers to polymeric compositions useful to adhere together two adherends. Examples of adhesives are pressure sensitive adhesives.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

The term “(meth)acrylate” refers to monomeric acrylic or methacrylic esters of alcohols. Acrylate and methacrylate monomers or oligomers are referred to collectively herein as “(meth)acrylates”. Materials referred to as “(meth)acrylate functional” are materials that contain one or more (meth)acrylate groups.

The terms “room temperature” and “ambient temperature” are used interchangeably to mean temperatures in the range of 20° C. to 25° C.

The terms “Tg” and “glass transition temperature” are used interchangeably. If measured, Tg values are determined by Differential Scanning calorimetry (DSC) at a scan rate of 10° C./minute, unless otherwise indicated. Typically, Tg values for copolymers are not measured but are calculated using the well-known Fox Equation, using the homopolymer Tg values provided by the monomer supplier, as is understood by one of skill in the art.

The term “adjacent” as used herein when referring to two layers means that the two layers are in proximity with one another with no intervening open space between them. They may be in direct contact with one another (e.g. laminated together) or there may be intervening layers.

The terms “polymer” and “macromolecule” are used herein consistent with their common usage in chemistry. Polymers and macromolecules are composed of many repeated subunits. As used herein, the term “macromolecule” is used to describe a group attached to a monomer that has multiple repeating units. The term “polymer” is used to describe the resultant material formed from a polymerization reaction.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The terms “free radically polymerizable” and “ethylenically unsaturated” are used interchangeably and refer to a reactive group which contains a carbon-carbon double bond which is able to be polymerized via a free radical polymerization mechanism.

Unless otherwise indicated, the terms “optically transparent”, and “visible light transmissive” are used interchangeably, and refer to an article, film or adhesive that has a high light transmittance over at least a portion of the visible light spectrum (about 400 to about 700 nm). Typically, optically transparent articles have a visible light transmittance of at least 90% and a haze of less than 10%.

Unless otherwise indicated, “optically clear” refers to an adhesive or article that has a high light transmittance over at least a portion of the visible light spectrum (about 400 to about 700 nm), and that exhibits low haze, typically less than about 5%, or even less than about 2%. In some embodiments, optically clear articles exhibit a haze of less than 1% at a thickness of 50 micrometers or even 0.5% at a thickness of 50 micrometers. Typically, optically clear articles have a visible light transmittance of at least 90%.

Disclosed herein are adhesive compositions comprising the reaction product of a reaction mixture that has been polymerized. The reaction mixture comprises: at least one first monomer comprising a methacrylate; at least one second monomer comprising a low Tg (meth)acrylate monomer with a Tg of −15° C. or less, the (meth)acrylate having an alkyl group with 2-20 carbon atoms; at least one third monomer comprising a high Tg monomer with a Tg of 70° C. or higher, the high Tg monomer comprising a (meth)acrylate monomer, a (meth)acrylamide monomer, or a vinyl-functional monomer; and at least one initiator. Each of these components is described in detail below.

The adhesives of this disclosure are pressure sensitive adhesives that are free from acid-functional groups and have a variety of desirable properties. The pressure sensitive adhesives are optically clear having a visible light transmission of 90%, a haze value of 1% or less, and a b* color value of 1 or less. The adhesives also have a dielectric constant (Dk) of 3.1 or less at 25° C. and 100 kHz. In some embodiments, the adhesives have a storage modulus (G′) as measured by Dynamical Mechanical Analysis (DMA) of 125 kiloPascals or less at 25° C. In addition, in some of the embodiments, the adhesives have desirable adhesive properties such as a 180° Peel Adhesion to glass of at least 1.65 kg/in at 25° C., and has a Tensile Adhesion to glass of at least 105 kg/in² at 25° C.

In addition to these desirable properties, the adhesives also have silver wire compatibility. Silver wire compatibility can be tested by elevated temperature and humidity aging. The adhesives have compatibility with Silver Nanowires (SNWs) such that when a SNW/adhesive/SNW construction is placed in a 65° C./90% RH chamber where RH is relative Humidity, and tested for anode resistance every 24 hours, the time to reach an anode resistance variation of greater than 10% is at least 96 days.

In some embodiments, the adhesive have desirable elevated temperature stability. There are a number of techniques that can be used to measure elevated temperature stability, including measurement of modulus, 180° Peel Adhesion, and Tensile Adhesion at elevated temperatures. In some embodiments, the current adhesives have a storage modulus (G′) as measured by Dynamical Mechanical Analysis (DMA) of 24 kiloPascals or more at 65° C.; a Tan Delta at 65° C. of 0.32 or greater, where Tan Delta is the calculated ratio (G″/G′) of the measured shear storage modulus (G′) and shear loss modulus (G″). Additionally, in some embodiments, the adhesives have a 180° Peel Adhesion to glass of at least 0.43 kg/in at 65° C.; and a Tensile Adhesion to glass of at least 31 kg/in² at 65° C.

The adhesives of this disclosure are prepared by the polymerization of a reaction mixture that comprises at least 3 monomers and an initiator and may comprise additional optional components if desired as long as these optional components do not interfere with the desirable properties of the formed adhesive.

The reaction mixture that forms the adhesive composition of this disclosure comprises at least one first monomer comprising a methacrylate. The first monomer is described by general Formula 1:

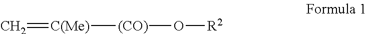

wherein (CO) is a carbonyl group; Me is a methyl group; and R² is linear or branched alkyl group with 8-16 carbon atoms.

A wide range of methacrylate monomers are suitable first monomers. The first monomer may be a single monomer or a combination of monomers. Examples of suitable methacrylate monomers include 2-ethylhexyl methacrylate, n-octyl methacrylate, isooctyl methacrylate, isononyl methacrylate, n-nonyl methacrylate, n-decyl methacrylate, isodecyl methacrylate, stearyl methacrylate, iso-tridecyl methacrylate, dodecyl methacrylate, isobornyl methacrylate, isostearyl acrylate and combinations thereof. Particularly suitable alkyl methacrylate monomer(s) include monomers of Formula 1 where R2 is a 2-ethyl hexyl group, a stearyl group, an iso-tridecyl group, or a dodecyl group.

The reaction mixture that forms the adhesive composition of this disclosure also comprises at least one second monomer comprising a low Tg (meth)acrylate monomer. By low Tg it is meant that the homopolymer Tg for the low Tg monomer is −15° C. or less. The second monomer comprises a (meth)acrylate of general Formula 2:

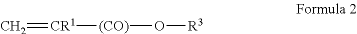

wherein R¹ is H or a methyl group; (CO) is a carbonyl group; and R³ is a linear or branched alkyl group with 2-20 carbon atoms and optionally comprising a hydroxyl group. The second monomer may be a single monomer or a combination of monomers. Since acrylates have lower Tgs than methacrylates, generally acylates are more useful monomers for use as the second monomer. Examples of suitable second monomers include 2-ethylhexyl acrylate, pentyl acrylate, n-octyl acrylate, isooctyl acrylate, isononyl acrylate, n-butyl acrylate, isobutyl acrylate, hexyl acrylate, n-nonyl acrylate, n-decyl acrylate, isodecyl acrylate, dodecyl acrylate, isostearylacrylate, 2-hydroxyethylacrylate (HEA), 2-propylheptyl acrylate, and combinations thereof.

In some embodiments, the second monomer is a monomer where R¹ is H (i.e. acrylates) and R³ is linear or branched alkyl group with 2-18 carbon atoms and optionally comprises a hydroxyl group. One class of suitable monomers are those where R³ is a 2-alkyl group, meaning that the R³ alkyl group is branched at the 2 position. The (meth)acrylates of this class are prepared by reacting a (meth)acrylic acid with a 2-alkanol (also known as a Guerbet alkanol). The resulting (meth)acrylates are thus sometimes referred to as Guerbet (meth)acrylates. In the Guerbet (meth)acrylates, the group R³ is described by Formula 3:

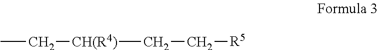

wherein R4 and R5 are each independently an alkyl group with 4-10 carbon atoms.

In some particularly suitable embodiments, the second monomer comprises a mixture of acrylate monomers, the mixture comprising at least 3 monomers (Monomer A, Monomer B, and Monomer C), wherein each of the at least 3 monomers comprise a monomer of general Formula 2:

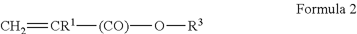

where Monomer A comprises a monomer in which R¹ is H; (CO) is a carbonyl group; and R³ is a linear alkyl group with 2 carbon atoms and a hydroxyl group; Monomer B is a monomer in which R¹ is H; (CO) is a carbonyl group; and R³ is a linear or branched alkyl group with 10-14 carbon atoms; and Monomer C is a monomer in which R¹ is H; (CO) is a carbonyl group; and R³ is a linear or branched alkyl group with 8-18 carbon atoms. Examples of suitable branched alkyl (meth)acrylates include those disclosed in U.S. Pat. No. 8,137,807.

The reaction mixture that forms the adhesive composition of this disclosure also comprises at least one third monomer comprising a high Tg monomer. By high Tg monomer it is meant a monomer with a homopolymer Tg of 70° C. or higher. The high Tg monomer may comprise a (meth)acrylate monomer, a (meth)acrylamide monomer, a vinyl-functional monomer, or a combination thereof. Examples of suitable (meth)acrylate monomers include, but are not limited to, methyl methacrylate, ethyl methacrylate, isopropyl methacrylate, n-butyl methacrylate, isobutyl methacrylate, s-butyl methacrylate, t-butyl methacrylate, stearyl methacrylate, cyclohexyl methacrylate, isobornyl acrylate, isobornyl methacrylate, 3,3,5-trimethylcyclohexyl acrylate, or combinations thereof. Examples of suitable (meth)acrylamide monomers include N,N-dimethyl (meth)acrylamide. Examples of suitable vinyl functional monomers include N-vinyl pyrrolidone (NVP) and N-vinyl caprolactam (NVC). Particularly suitable third monomers include isobornyl (meth)acrylate, N,N-dimethyl (meth)acrylamide, N-vinyl pyrrolidone (NVP), and N-vinyl caprolactam (NVC).

The reaction mixture that forms the adhesive composition of this disclosure also comprises at least one initiator. While both thermal polymerization and photopolymerization methods could be used, typically photopolymerization is used. In a typical photopolymerization method, a monomer mixture may be irradiated with ultraviolet (UV) rays in the presence of a photopolymerization initiator (i.e., photoinitiators). Suitable photoinitiators are those available under the trade designations IRGACURE and DAROCUR from Ciba Specialty Chemical Corp., Tarrytown, NY and include 1-hydroxy cyclohexyl phenyl ketone (IRGACURE 184), 2,2-dimethoxy-1,2-diphenylethan-1-one (IRGACURE 651), bis(2,4,6-trimethylbenzoyl)phenylphosphineoxide (IRGACURE 819), 1-[4-(2-hydroxyethoxy)phenyl]-2-hydroxy-2-methyl-1-propane-1-one (IRGACURE 2959), 2-benzyl-2-dimethylamino-1-(4-morpholinophenyl) butanone (IRGACURE 369), 2-methyl-1-[4-(methylthio)phenyl]-2-morpholinopropan-1-one (IRGACURE 907), and 2-hydroxy-2-methyl-1-phenyl propan-1-one (DAROCUR 1173). Particularly suitable photoinitiators are IRGACURE 819, 651, 184 and 2959. The photoinitiators are typically used in amounts of 0.02-0.35% by weight based on the total weight of reactive monomers.

The adhesives of this disclosure may also contain one or more conventional additives. Suitable additives include tackifiers, plasticizers, dyes, antioxidants, and UV stabilizers. Such additives can be used if they do not adversely affect the properties of the adhesives.

Besides the wide range of monomers suitable, a wide range of monomer compositions are likewise suitable. In some embodiments, the reaction mixture contains:
10-20% by weight first monomer;
70-85% by weight second monomer; and
2-17% by weight third monomer.

A wide range of polymerization methods can be used to carry out the polymerization of the reaction mixture described in detail above. The polymerization may be carried out with a solvent, or in a solventless process. Solventless processes are generally more desirable. In some embodiments, a coat and cure method is used. In this method, the reactive components are mixed together and a small amount of photoinitiator is added. The initiator is activated to form a syrup that has a coatable viscosity. Additional photoinitiator is added to the syrup and the syrup is coated on release liner. Typically, a second release liner is placed on top of the coated syrup. The coated syrup is exposed to radiation to activate the photoinitiator, cure the syrup, and form a layer of the adhesive of this disclosure.

Also disclosed herein are articles that contain the adhesives of this disclosure. In some embodiments, the adhesive article comprises a first substrate with a first major surface and a second major surface and an adhesive layer disposed on at least a portion of the second major surface of the first substrate. The adhesive layer comprises the adhesive described above. The adhesive comprises the reaction product of a mixture comprising at least one first monomer comprising a methacrylate; at least one second monomer comprising a low Tg (meth)acrylate monomer with a Tg of −15° C. or less, the (meth)acrylate having an alkyl group with 2-20 carbon atoms; at least one third monomer comprising a high Tg monomer with a Tg of 70° C. or higher, wherein the high Tg monomer comprises a (meth)acrylate monomer, a (meth)acrylamide monomer, or a vinyl-functional monomer; and at least one initiator.

The adhesive is pressure sensitive adhesives that is free from acid-functional groups and has a variety of desirable properties. The pressure sensitive adhesive is optically clear having a visible light transmission of 90%, a haze value of 1% or less, and a b* color value of 1 or less. The adhesive also has a dielectric constant (Dk) of 3.1 or less at 25° C. and 100 kHz. In some embodiments, the adhesive has storage modulus (G′) as measured by Dynamical Mechanical Analysis (DMA) of 125 kPa (kiloPascals) or less at 25° C. In addition, in some embodiments, the adhesive has desirable adhesive properties such as a 180° Peel Adhesion to glass of at least 1.65 kg/in at 25° C., and has a Tensile Adhesion to glass of at least 105 kg/in² at 25° C.

In addition to these desirable properties, the adhesive also has elevated temperature stability and silver wire compatibility. There are a number of techniques that can be used to measure elevated temperature stability, including measurement of modulus, 180° Peel Adhesion, and Tensile Adhesion at elevated temperatures. Silver wire compatibility can be tested by elevated temperature and humidity aging. In some embodiments, the current adhesives have a storage modulus (G′) as measured by Dynamical Mechanical Analysis (DMA) of 24 kiloPascals or more at 65° C.; a Tan Delta at 65° C. of 0.32 or greater, where Tan Delta is the calculated ratio (G″/G′) of the measured shear storage modulus (G′) and shear loss modulus (G″). Additionally, the adhesives, in some embodiments, have a 180° Peel Adhesion to glass of at least 0.43 kg/in at 65° C.; and a Tensile Adhesion to glass of at least 31 kg/in² at 65° C. The adhesives have compatibility with Silver Nanowires (SNWs) such that when a SNW/adhesive/SNW construction is placed in a 65° C./90% RH chamber where RH is Relative Humidity and tested for anode resistance every 24 hours, the time to reach an anode resistance variation of greater than 10% is at least 96 days.

A wide range of substrates are suitable in the articles of this disclosure. In some embodiments, the substrate is a release liner. In the method described above, the formed adhesive layer is disposed on a release liner. These articles are very useful for forming a wide range of other articles since the exposed adhesive layer can be laminated to the surface of a substrate and the release liner can be removed to expose a second adhesive surface.

In many embodiments, the first substrate is substantially transparent. In many embodiments, the first substrate is optically clear. The first substrate may be rigid, semi-rigid or flexible. Examples of rigid substrates include plates such as glass plates, PMMA (polymethylmethacrylate) plates, or PC (polycarbonate) plates or the surface of an electronic or optical device. Examples of semi-rigid substrates include, for example, multi-layer films where the number of layers or the thickness of the layers hinder the flexibility, such as bendability. Examples of flexible substrates include film substrates such as optical films.

In some embodiments, the second major surface of the first substrate comprises silver nanowires. Silver nanowires are used in a wide range of electronic devices.

In some embodiments, the article further comprises a second substrate, where the second substate comprises a first major surface and a second major surface, and the first major surface of the second substrate is disposed on the adhesive layer. The second substrate may be the same as the first substrate or it may be different. The second substrate, like the first substrate may be selected from the substrates described above for the first substrate.

In some embodiments, the first major surface of the second substrate comprises silver nanowires.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wisconsin unless otherwise noted. The following abbreviations are used: cm=centimeters; mm=millimeters; in=inch; kg=kilograms; kgf=kilogram force; min=minutes; hr=hours; PSI=pounds per square inch; mJ=milliJoules; Ω=ohms; and RH=Relative Humidity. The terms “weight %”, “% by weight”, and “wt %” are used interchangeably.

Table of Abbreviations

| Acronym | Name | Supplier |
|---|---|---|
| LA | Lauryl acrylate | |
| C17A | Heptadecyl Acrylate | BASF, Germany |
| DMAA | N,N-Dimethylacrylamide | KJ chemicals Co., Japan |
| HEA | Hydroxyethyl acrylate | Nippon Shokubai Co., |
| | | Ltd., Japan |
| IBOA | Isobornyl acrylate | Osaka Organic Chemical |
| | | Industry Ltd. |
| ISTA | Isostearyl acrylate | Shin Nakamura chemical |
| | | Co., Japan |
| LMA | Lauryl Methacrylate | Kyoeisha Chemical Co. |
| | | Ltd., Japan |
| 2-EHA | 2-Ethylhexyl acrylate | Formosa Plastics Co. |
| | | Ltd., Taiwan |
| 2-EHMA | 2-Ethylhexyl methacrylate | Sigma-Aldrich Co., St. |
| | | Louis, MO |
| NVP | N-Vinylpyrrolidone | Nippon Shokubai Co., |
| | | Ltd., Japan |
| NVC | N-Vinyl caprolactam | BASF, Germany |
| Liner-1 | Release liner, RF12N | SKC Haas, Korea |
| Liner-2 | Release liner, RF02N | SKC Haas, Korea |

### Test Methods

### Optical Properties

Haze measurements were made using a HunterLab (Reston, VA) UltrascanPro Spectrophotometer in transmission mode. The assembly layer was coated between release-coated carrier liners (Liner-1 and Liner-2) and was cut to approximately 5 cm width by 10 cm length and their thickness was measured. One of the carrier liners was removed and the sample was laminated to a clear piece of 1 mm thick glass. The other liner was then removed and another 1 mm thick glass was laminated onto the assembly layer. The sample was autoclaved 20 min under 50° C./45 PSI to remove entrapped air. Then the sample was placed in the UltrascanPro Spectrophotometer to measure transmission and color through the glass/OCA/glass assembly. Additional samples were prepared and aged in a chamber set to 65° C./90% relative humidity for 800 hours. After samples were removed from the humidity chamber and allowed to cool, haze measurements were again conducted. Typically, samples acceptable for optical applications have haze values of less than about 1%, and b* color values of less than about 1.

### Dynamic Mechanical Analysis (DMA)

Samples were evaluated for their tan delta at 150° C. using a rheological dynamic analyzer (Model ARES-G2 Rheometer, which is available from TA Instruments, New Castle, DE, USA). Samples (as described in example section) were laminated to a thickness of approximately 2 mm. Samples were then punched out using an 8 mm (0.315 inches) diameter circular die and adhered onto an 8 mm diameter upper parallel plate after removal of the release liner. The plate with polymeric film was positioned between the clamps, and the polymeric film compressed until the edges of the sample were uniform with the edges of the top plate. The temperature was then equilibrated at the test temperatures for 2 minutes at a nominal axial force of 0 grams+/−15 grams. After two minutes, the axial force controller was disabled in order to maintain a fixed gap during the remainder of the test. The sample was oscillated at 1 Hz and was taken from −50° C. to 150° C. at 3° C./min. Tan delta values at 65° C. were recorded.

### Peel Adhesion & Tensile Strength

Peel adhesion and tensile strength were measured at 74° F. (23° C.) and 50% relative humidity (RH) using an IMASS Model 2100 Slip/Peel Tester (Instrumentors Incorporated, Strongsville, OH) equipped with a 25-pound load cell. Peeling adhesion sample was prepared by using 10 mm wide tested OCA strip. The easy-side liner side is first laminated to a 51 micrometer (2 mil) PET strip, then its tight-side is laminated to float glass (cleaned by acetone/n-heptane) with a 2 kg roller. Then put the construction in autoclaves under 50° C./3 kg for 20 min and left at ambient environment for 24 hours before the 180° peel test is conducted. Peel speeds is 12″/min (30 cm/min). Five test specimens were evaluated and the results used to obtain an average value in kilogram/inch and converted to N/mm (Newtons/millimeter).

Tensile strength sample was prepared by using 0.5 in×0.5 in (13 mm×13 mm) tested OCA. The OCA easy liner side is first laminated to the center float glass (cleaned by acetone/n-heptane) then aligned the top float glass perpendicularly and laminated its tight liner side on the top float glass. Then put the construction in autoclaves under 50° C./3 kg for 20 min and left at ambient environment for 24 hours before the tensile strength test is conducted. Test speed is 1 in/min (2.54 cm/min). Five test specimens were evaluated and the results used to obtain an average value in kilogram/in² and converted to kg/cm² (kilograms/square centimeters).

### SNW Compatibility

A SNW (silver nanowire) sheet with multimeter (normal resistance range of 50-200Ω) and cut into 72 mm*60 mm size. The conductive side was laminated with OCA (size 60 mm*60 mm) to form a construction of SNW/OCA/SNW with 6 mm SNW exposed for painting of a silver line. Two parallel silver paint lines were painted on the conductive SNW side and copper tape was added to each of the four silver painted spots and then folded. The coupon samples were autoclaved under 40° C., 3 kgf/cm², 5 min.

The coupon test was run in a 65° C./90% RH chamber and connected to a 5V current with “Lo” MΩ on a voltmeter. The anode resistance data was measured every 24 hr and the test was stopped when the resistance variation was >10% (compared to T0 resistance).

### Examples E1-E6 and Comparative Examples CE1-CE4

### Preparation of Solventless Based PSA Samples

Assembly layer films were prepared according to the formulations provided in Table 1. The polymerization/coating process involved preparing the reactive mixture, irradiating to partially polymerize to form a coatable syrup, coating the syrup on a release liner, and the coated layer was further irradiated to full polymerization. The PSA construction was irradiated with a total dose of 1500 mJ/cm² of UV-A. Examples E1-E6 and Comparative Examples CE1-CE4 were prepared with the materials and amounts described in Table 1. The thickness or all PSA examples was 150 micrometers (6 mil).

The adhesive samples were tested for modulus (by the DMA test described above) and SNW compatibility using the test method described above. The data are presented in Table 2.

The adhesive samples were tested for Peel Adhesion and Tensile Adhesion on glass using the test methods described above. The data are presented in Table 3.

TABLE 1
PSA Samples Preparation

| | Methacrylat | | Low T_{g} Acrylate | | | | | High T_{g} Acrylate | | | |
|---|---|---|---|---|---|---|---|---|---|---|---|
| Monomer type | 2EHM | LMA | HEA | ISTA | LA | 2EHA | C17A | DMA | IBOA | NVP | NVC |
| Monomer T_{g} | −10 | −50 | −15 | −18 | −46 | −50 | −64 | 77 | 94 | 120 | 184 |
| E1-A | | 11 | 9 | 45 | 35 | | | | | | 12 |
| E1-B | | | | | | | | 11 | | | |
| E2-A | | 11 | 9 | 55 | 25 | | | | | | 11 |
| E2-B | | | | | | | | | 17 | | |
| E2-C | | | | | | | | 9 | | | |
| E3-A | | 15 | 9 | 55 | | | 21 | | | | 11 |
| E4-A | | 12 | 9 | 60 | 19 | | | | 13 | | |
| E4-B | | | | | | | | | | | 8 |
| E4-C | | | | | | | | | | 8 | |
| E4-D | | | | | | | | 10 | | | |
| E5-A | | 17 | 9 | 60 | | | 14 | | | | 8 |
| E5-B | | | | | | | | | | 8 | |
| E6-A | | 20 | 9 | 71 | | | | | 8 | | |
| E6-B | | | | | | | | | | | 3 |
| C1-A | 12 | | 9 | 60 | 19 | | | | | | 8 |
| C1-B | | | | | | | | | | 8 | |
| C2-A | | 12 | 9 | 60 | | 19 | | | | | 8 |
| C2-B | | | | | | | | | 13 | | |
| C3-A | 12 | | 9 | 60 | | 19 | | | | | 8 |
| C3-B | | | | | | | | | | 8 | |
| C4 | 14 | | 9 | 67 | | 10 | | | | | |

TABLE 2
25° C., 65° C. modulus/tan delta, and SNW compatibility results

| | Monomer | Dk @ | 25° C. | 65° C. modulus | 65° C. | SNW compatibility |
|---|---|---|---|---|---|---|
| Item | adding | 25° C. | modulus | (kPa) | tan delta | (anode resist >10%, hr) |
| E1-A | NVC | 3.02 | 82 | 24 | 0.34 | 168 |
| E1-B | DMAA | 3.06 | 78 | 26 | 0.33 | 96 |
| E2-A | NVC | 2.83 | 108 | 29 | 0.32 | 192 |
| E2-B | IBOA | 2.83 | 102 | 26 | 0.35 | 408 |
| E2-C | DMAA | 2.98 | 123 | 33 | 0.33 | 192 |
| E3-A | NVC | 2.86 | 85 | 25 | 0.37 | 240 |
| E4-A | IBOA | 2.85 | 94 | 26 | 0.33 | 192 |
| E4-B | NVC | 2.79 | 102 | 27 | 0.39 | 384 |
| E4-C | NVP | 2.82 | 97 | 26 | 0.38 | 120 |
| E4-D | DMAA | 2.89 | 106 | 28 | 0.35 | 216 |
| E5-A | NVC | 2.81 | 100 | 24 | 0.41 | 384 |
| E5-B | NVP | 2.83 | 108 | 26 | 0.38 | 264 |
| E6-A | IBOA | 2.64 | 108 | 24 | 0.44 | >500 |
| E6-B | NVC | 2.78 | 106 | 24 | 0.44 | >500 |
| C1-A | NVC | 2.75 | 155 | 31 | 0.4 | 360 |
| C1-B | NVP | 2.80 | 142 | 30 | 0.38 | 96 |
| C2-A | NVC | 2.89 | 104 | 30 | 0.34 | 216 |
| C2-B | IBOA | 2.96 | 98 | 31 | 0.31 | 144 |
| C3-A | NVC | 2.86 | 160 | 34 | 0.38 | 264 |
| C3-B | NVP | 2.91 | 127 | 30 | 0.36 | 48 |
| C4 | — | 2.99 | 88 | 15 | 0.6 | 216 |

TABLE 3
25° C., 65° C. peeling adhesion & tensile adhesion results on glass

| | 25° C. | 25° C. | 65° C. | 65° C. |
|---|---|---|---|---|
| | adhesion | Tensile | adhesion | Tensile |
| | kg/in, | kg/in², | kg/in, | (kg/in²), |
| Item | (N/mm) | (kg/cm²) | (N/mm) | (kg/cm²) |
| E1-A | 1.90 (0.73) | 179.84 (27.88) | 0.60 (0.23) | 53.09 (8.23) |
| E1-B | 1.68 (0.65) | 165.66 (25.68) | 0.62 (0.24) | 51.42 (7.97) |
| E2-A | 2.32 (0.90) | 129.72 (20.11) | 0.75 (0.29) | 38.82 (6.02) |
| E2-B | 1.99 (0.77) | 180.34 (27.95) | 0.45 (0.17) | 47.11 (7.30) |
| E2-C | 2.12 (0.82) | 172.92 (26.80) | 0.69 (0.27) | 48.44 (7.51) |
| E3-A | 1.69 (0.65) | 118.93 (18.43) | 0.57 (0.22) | 39.10 (6.06) |
| E4-A | 1.98 (0.76) | 107.25 (16.62) | 0.43 (0.17) | 31.08 (4.82) |
| E4-B | 2.45 (0.95) | 121.05 (18.76) | 0.65 (0.25) | 40.30 (6.25) |
| E4-C | 2.20 (0.85) | 121.51 (18.83) | 0.61 (0.24) | 32.76 (5.08) |
| E4-D | 1.94 (0.75) | 149.11 (23.11) | 0.58 (0.22) | 54.92 (8.51) |
| E5-A | 2.07 (0.80) | 159.87 (24.78) | 0.69 (0.27) | 41.87 (6.49) |
| E5-B | 1.88 (0.73) | 130.13 (20.17) | 0.56 (0.22) | 30.50 (4.73) |
| E6-A | 2.28 (0.88) | 153.19 (23.74) | 0.46 (0.18) | 38.72 (6.00) |
| E6-B | 2.26 (0.87) | 148.28 (22.98) | 0.50 (0.19) | 36.19 (5.61) |
| C1-A | 2.69 (1.04) | 180.88 (28.04) | 0.86 (0.33) | 40.41 (6.26) |
| C1-B | 2.47 (0.95) | 161.62 (25.05) | 0.79 (0.30) | 43.39 (6.73) |
| C2-A | 2.06 (0.80) | 112.40 (17.42) | 0.63 (0.24) | 38.50 (5.97) |
| C2-B | 2.00 (0.77) | 124.95 (19.37) | 0.58 (0.22) | 37.63 (5.83) |
| C3-A | 2.50 (0.97) | 160.48 (24.87) | 0.81 (0.31) | 47.88 (7.42) |
| C3-B | 2.35 (0.91) | 158.16 (24.51) | 0.74 (0.29) | 42.76 (6.63) |
| C4 | 2.42 (0.93) | 105.55 (16.36) | 0.30 (0.12) | 22.45 (3.48) |

What is claimed is:

1. An adhesive comprising:
the reaction product of a mixture comprising:
at least one first monomer comprising a methacrylate;
at least one second monomer comprising a low Tg (meth)acrylate monomer with a Tg
of −15° C. or less, the (meth)acrylate having an alkyl group with 2-20 carbon atoms;
at least one third monomer comprising a high Tg monomer with a Tg of 70° C. or higher,
wherein the high Tg monomer comprises a (meth)acrylate monomer, a (meth)acrylamide monomer, or a vinyl-functional monomer; and
at least one initiator;
wherein the adhesive is free from acid-functional groups; is a pressure sensitive adhesive;
is optically clear having a visible light transmission of 90%, a haze value of 1% or less, and a b* color value of 1 or less; and has a dielectric constant (Dk) of 3.1 or less at 25° C. and 100 kHz.

2. The adhesive of claim 1, wherein the adhesive has a Silver Nanowire (SNW) compatibility such that upon testing of an SNW/adhesive/SNW construction when placed in a 65° C./90% RH chamber and tested for anode resistance every 24 hours, the time to reach an anode resistance variation of greater than 10% is at least 96 days.

3. The adhesive of claim 1, wherein the first monomer comprises a methacrylate of general Formula 1: 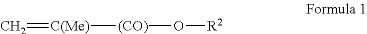
wherein (CO) is a carbonyl group;
Me is a methyl group; and
R² is linear or branched alkyl group with 8-16 carbon atoms.

4. The adhesive of claim 1, wherein the first monomer comprises a methacrylate of general Formula 1: 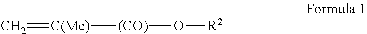
wherein (CO) is a carbonyl group;
Me is a methyl group; and
R² is a 2-ethyl hexyl group, a stearyl group, a iso-tridecyl group, or a dodecyl group.

5. The adhesive of claim 1, wherein the second monomer comprises a (meth)acrylate of general Formula 2: 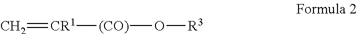
wherein R¹ is H or a methyl group;
(CO) is a carbonyl group; and
R³ is a linear or branched alkyl group with 2-20 carbon atoms and optionally comprising a hydroxyl group.

6. The adhesive of claim 1, wherein the second monomer comprises an acrylate of general Formula 2: 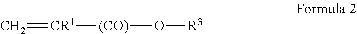
wherein R¹ is H;
(CO) is a carbonyl group; and
R³ is a linear or branched alkyl group with 2-18 carbon atoms and optionally comprising a hydroxyl group.

7. The adhesive of claim 1, wherein the second monomer comprises a mixture of acrylate monomers, the mixture comprising at least 3 monomers (Monomer A, Monomer B, and Monomer C), wherein each of the at least 3 monomers comprise a monomer of general Formula 2: 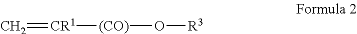
such that:
in Monomer A:
R¹ is H;
(CO) is a carbonyl group; and
R³ is a linear alkyl group with 2 carbon atoms and a hydroxyl group;
in Monomer B:
R¹ is H;
(CO) is a carbonyl group; and
R³ is a linear or branched alkyl group with 10-14 carbon atoms; and
In Monomer C:
R¹ is H;
(CO) is a carbonyl group; and
R³ is a linear or branched alkyl group with 8-18 carbon atoms.

8. The adhesive of claim 1, wherein the third monomer comprises:
at least one selected from isobornyl (meth)acrylate; N,N-dimethyl (meth)acrylamide; N-vinyl pyrrolidone (NVP); and N-vinyl caprolactam (NVC).

9. The adhesive of claim 1, wherein the reactive components of the reaction mixture comprise:
10-20% by weight first monomer;
70-85% by weight second monomer; and
2-17% by weight third monomer.

10. An adhesive article comprising:
a first substrate with a first major surface and a second major surface; and
an adhesive layer disposed on at least a portion of the second major surface of the first substrate, the adhesive layer comprising the reaction product of a mixture comprising:
at least one first monomer comprising a methacrylate;
at least one second monomer comprising a low Tg (meth)acrylate monomer with a Tg
of −15° C. or less, the (meth)acrylate having an alkyl group with 2-20 carbon atoms;
at least one third monomer comprising a high Tg monomer with a Tg of 70° C. or higher, wherein the high Tg monomer comprises a (meth)acrylate monomer, a (meth)acrylamide monomer, or a vinyl-functional monomer; and
at least one initiator;
wherein the adhesive is free from acid-functional groups; is a pressure sensitive adhesive;
is optically clear having a visible light transmission of 90%, a haze value of 1% or less, and a b* color value of 1 or less; has a dielectric constant (Dk) of 3.1 or less at 25° C. and 100 kHz.

11. The adhesive article of claim 10, wherein the adhesive has silver wire compatibility such that:
the adhesive has a Silver Nanowire (SNW) compatibility such that upon testing of an SNW/adhesive/SNW construction when placed in a 65° C./90% RH chamber and tested for anode resistance every 24 hours, the time to reach an anode resistance variation of greater than 10% is at least 96 days.

12. The adhesive article of claim 10, wherein the first substrate comprises a release liner.

13. The adhesive article of claim 10, wherein the second major surface of the first substrate comprises silver nanowires.

14. The adhesive article of claim 10, wherein the article further comprises a second substrate, wherein the second substate comprises a first major surface and a second major surface, and wherein the first major surface of the second substrate is disposed on the adhesive layer.

15. The adhesive article of claim 14, wherein the first major surface of the second substrate comprises silver nanowires.
